(19) United States
(12) Patent Application Publication
(10) Pub. No.: US 2025/0316775 A1
(43) Pub. Date: Oct. 9, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Yeon Ho LEE, Suwon-si (KR); Sang Hyun PARK, Suwon-si (KR); Hyeon Seon CHOI, Suwon-si (KR)

(73) Assignee: SAMSUNG SDI CO., LTD., Yongin-si (KR)

(21) Appl. No.: 19/096,120

(22) Filed: Mar. 31, 2025

(30) Foreign Application Priority Data
Apr. 3, 2024 (KR) 10-2024-0045099

(51) Int. Cl. H01M 10/42; H01M 10/052; H01M 50/417; H01M 50/42; H01M 50/434; H01M 50/443; H01M 50/446; H01M 50/449; H01M 50/489

(52) U.S. Cl. CPC H01M 10/4235; H01M 10/052; H01M 50/417; H01M 50/42; H01M 50/434; H01M 50/443; H01M 50/446; H01M 50/449; H01M 50/489

(57) ABSTRACT

Examples of the present disclosure relate to a separator for a rechargeable lithium battery, and a rechargeable lithium battery including the separator, and are directed to providing a separator for a rechargeable lithium battery. The separator includes a porous substrate and a coating layer located on at least one surface of the porous substrate. The coating layer includes a binder and a filler, the filler includes a core-shell particle as a first particle, the core includes an organic component having a melting point lower than a melting point of the porous substrate, and the shell includes an inorganic component having a melting point higher than the melting point of the organic component.

### CROSS-REFERENCE TO RELATED APPLICATION

The present application claims the benefit of priority to Korean Patent Application No. 10-2024-0045099, filed on Apr. 3, 2024 in the Korean Intellectual Property Office, the entire disclosure of which is incorporated herein by reference.

### BACKGROUND

### 1. Field of the Disclosure

The present disclosure relates to a separator for a rechargeable lithium battery and a rechargeable lithium battery including the same.

### 2. Discussion of Related Art

With increasing presence of electronic devices using batteries, such as, e.g., mobile phones, notebook computers, electric vehicles, and the like, the demand for secondary batteries having high energy density and high capacity is increasing. Therefore, improving the performance of rechargeable lithium batteries may be advantageous.

A rechargeable lithium battery typically includes a positive electrode and a negative electrode that contain an active material capable of the intercalation and deintercalation of lithium ions, and produces electrical energy by oxidation and reduction reactions when the lithium ions are intercalated into and deintercalated from the positive electrode and the negative electrode.

The rechargeable lithium battery may further include a separator between the positive electrode and the negative electrode. The separator may have low membrane resistance, high heat resistance, resulting in low heat shrinkage.

### SUMMARY OF THE DISCLOSURE

One example embodiment includes a separator for a rechargeable lithium battery, the separator including a high coating density in a small thickness, a uniform shutdown function over substantially the entire surface of a battery, and desired or improved battery manufacturing processability.

Another example embodiment includes a rechargeable lithium battery including the separator.

According to one example embodiment, a separator for a rechargeable lithium battery includes a porous substrate and a coating layer located on at least one surface of the porous substrate. The coating layer includes a binder and a filler, the filler includes a core-shell particle as a first particle, the core includes an organic component having a melting point lower than a melting point of the porous substrate, and the shell includes an inorganic component having a melting point higher than the melting point of the organic component.

According to another example embodiment, a rechargeable lithium battery includes a positive electrode, a negative electrode, and the separator for a rechargeable lithium battery, the separator being located between the positive electrode and the negative electrode.

### BRIEF DESCRIPTION OF THE DRAWINGS

FIGS. 1 to 4 are schematic cross-sectional views illustrating a rechargeable lithium battery, according to one example embodiment.

### DETAILED DESCRIPTION

Hereinafter, example embodiments of the present disclosure are described in detail. However, the embodiments are presented as examples, the present disclosure is not limited thereto, and the present disclosure is only defined by the scope of the appended claims.

Unless otherwise stated herein, when a part such as a layer, a membrane, an area, a plate, etc. is described as being disposed “on” another part, it includes not only a case where the part is “directly on” another part, but also a case where there are other parts therebetween.

Unless otherwise stated herein, the singular may also include the plural. In addition, unless otherwise stated, the term “A or B” may indicate “including A, including B, or including A and B.”

In the present specification, “a combination thereof” may indicate a mixture, stack, composite, copolymer, alloy, blend, or reaction product of constituents.

Unless otherwise defined herein, a particle diameter may be an average particle diameter. In addition, the particle diameter refers to an average particle diameter D50, which refers to a diameter of a particle with a cumulative volume of 50% by volume in a particle diameter distribution. The average particle diameter D50 may be measured by methods known to those skilled in the art and for example, may be measured using a particle size analyzer, a transmission electron microscope photograph, or a scanning electron microscope photograph. As another method, the average particle diameter D50 may be obtained by measuring the particle diameter using a measuring device using dynamic light scattering, performing data analysis to count the number of particles for each particle size range, and calculating the average particle diameter D50 therefrom. Alternatively, the average particle diameter D50 may be measured using a laser diffraction method. When measuring the average particle diameter by the laser diffraction method, for example, the average particle diameter D50 based on 50% of a particle diameter distribution in the measuring device may be calculated by dispersing particles to be measured in a dispersion medium, introducing the dispersion medium into a commercially available laser diffraction particle diameter measuring device (e.g., Microtrac's MT 3000), and radiating ultrasonic waves of about 28 kHz with an output of 60 W.

In the present specification, “(meth)acryl” refers to acryl and/or methacryl.

Hereinafter, unless otherwise defined, “substitution” indicates that hydrogen in a compound is substituted with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxy group (—OH), a nitro group (—NO₂), a cyano group (—CN), an amino group (—NRR′) (here, R and R′ are each independently hydrogen or a C1 to C6 alkyl group), a sulfobetaine group (—RR′N+ (CH₂)ₙSO₃—, n is a natural number from 1 to 10), a carboxybetaine group (—RR′N+ (CH₂)ₙCOO—, n is a natural number from 1 to 10) (here, R and R′ are each independently a C1 to C20 alkyl group), an azido group (—N₃), an amidino group (—C(═NH)NH₂), a hydrazino group (—NHNH₂), a hydrazono group (═N(NH₂)), a carbamoyl group (—C(O)NH₂), a thiol group (—SH), an acyl group (—C(═O)R, here, R indicates hydrogen, a C1 to C6 alkyl group, a C1 to C6 alkoxy group, or a C6 to C12 aryl group), a carboxyl group (—COOH) or a salt thereof (—C(═O)OM, here, M indicates an organic or inorganic cation), a sulfonic acid group (—SO₃H) or a salt thereof (—SO₃M, here, M indicates an organic or inorganic cation), a phosphate group (—PO₃H₂) or a salt thereof (—PO₃MH or —PO₃M₂, here, M indicates an organic or inorganic cation), and a combination thereof.

Hereinafter, the C1 to C3 alkyl group may be or include at least one of a methyl group, an ethyl group, or a propyl group. The C1 to C10 alkylene group may be or include, for example, at least one of a C1 to C6 alkylene group, a C1 to C5 alkylene group, or a C1 to C3 alkylene group and may be or include, for example, at least one of a methylene group, an ethylene group, or a propylene group. The C3 to C20 cycloalkylene group may be or include, for example, at least one of a C3 to C10 cycloalkylene group, or a C5 to C10 cycloalkylene group, for example, a cyclohexylene group. The C6 to C20 arylene group may be or include, for example, a C6 to C10 arylene group, for example, a phenylene group. The C3 to C20 heterocyclic group may be or include, for example, a C3 to C10 heterocyclic group, for example, a pyridine group.

Hereinafter, “hetero” indicates including one or more heteroatoms such as or including at least one of N, O, S, Si, and P.

In addition, in the chemical formulas, the symbol * refers to a part that is connected to the same or different atom, group, or structural unit.

Hereinafter, “alkali metal” refers to an element belonging to Group 1 of the periodic table, such as lithium, sodium, potassium, rubidium, cesium, or francium and may be present in a cationic or neutral state.

In the present specification, when describing a numerical range, “X to Y” indicates “X or more and Y or less (X≤ and ≤Y).”

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

A separator for a rechargeable lithium battery according to one example embodiment includes a porous substrate and a coating layer located on at least one surface of the porous substrate. The coating layer includes a binder and a filler, the filler includes a core-shell particle as a first particle, the core includes an organic component having a melting point lower than a melting point “Tm” of the porous substrate, and the shell includes an inorganic component having a melting point higher than the melting point of the organic component.

The coating layer may be located on only one surface of the porous substrate, or may be located on both surfaces thereof.

### Coating Layer

The coating layer includes a filler, and the filler includes a core-shell particle as a first particle.

A particle diameter D50 of the core-shell particle may be equal to about 800 nm or less, for example, may be greater than 0 nm and 800 nm or less, may range from 100 to 800 nm or from 500 to 800 nm, for example 100, 150, 200, 250, 300, 350, 400, 450, 500, 550, 600, 650, 700, 750, 800 nm. Within the above range, the particle diameter D50 of the core-shell particle can be advantageous in providing high coating density.

The core includes an organic component having a melting point lower than a melting point of the porous substrate. Therefore, the core may increase the internal resistance of the battery and lower the reactivity of the battery by blocking pores of the porous substrate by melting the organic component in the event of the battery overheat generation and/or a fire. Therefore, the core can reduce or suppress the heat generation of the battery early by providing a shutdown function.

The shell may surround at least one surface of the core, for example, substantially the entire surface of the core. The shell can reduce or prevent the agglomeration of the core-shell particles in a composition for a coating layer even when the core-shell particle have a small particle diameter, thereby increasing dispersibility. When the core-shell particle has a significantly small diameter, the dispersibility of the particle may be low, which may be a limitation in increasing coating density. On the other hand, the shell can be advantageous in providing a uniform shutdown function over substantially the entire surface of the battery by increasing coating density and the dispersibility of particles.

The shell includes an inorganic component having a melting point higher than the melting point of the organic component. Therefore, the shell can increase the manufacturing processability of the battery by a hot pressing process. Herein, “hot pressing process” is a process of pressing a laminate or a plurality of laminates in which a separator is located between electrodes including a positive electrode and a negative electrode, between electrodes including a positive electrode and a positive electrode, or between electrodes including a negative electrode and a negative electrode within a predetermined temperature range, for example, of about 60° C. to about 100° C. and a desired or predetermined pressure range of about 0.5 MPa to about 4.0 MPa. The hot pressing process can increase the mechanical strength and lifetime of the battery by increasing a degree of adhesion between the electrodes and the separator.

According to one example embodiment, the shell may have a thickness that is significantly lower than a diameter of the core among the core-shell particles. This indicates that when a temperature of the battery, for example, the coating layer, overheats in the event of the battery overheat generation and/or a fire, the organic component expands and the shell is readily destroyed, thereby enabling a shutdown function by the organic component. For example, a thickness of the shell may be about 10% or less of the diameter of the core, for example, more than 0% and 10% or less, 5% or less, or 1% or less.

According to one example embodiment, in the core-shell particle, the core may contain a portion of an interpenetrating polymer-inorganic network structure of the organic component and the inorganic component.

Here, “interpenetrating polymer-inorganic network structure” is a structure in which the organic component and the inorganic component are tangled like a net. This indicates that in a process of forming the core-shell particle, a precursor of the organic component and a precursor of the inorganic component are contained in one space, for example, a micelle, and the cross-linking of the precursor of the organic component and the condensation of the precursor of the inorganic component occur almost simultaneously or contemporaneously, and thus the core-shell particle may be prepared. After the core is prepared, the shell may be prepared by diffusing and condensing the precursor of the inorganic component from the core. Therefore, an interface between the core and the shell is not distinguished, and the core and the shell may be formed substantially continuously. The above structure can facilitate the preparation of the core-shell particle having a relatively small particle diameter D50 and the preparation of a thin shell. In addition, the structure allows the inorganic component of the core and the shell to be formed substantially continuously, making it easier to destroy the shell due to the expansion of the organic component in the event of a fire, thereby further lowering a shutdown temperature.

According to one example embodiment, the core, that is, the organic component in the core may contain a polymer having a melting point ranging from about 80° C. to 140° C. Within the above range, a temperature at which shutdown begins can be lowered, the heat generation of the battery can be reduced or suppressed early, and material supply can be facilitated. For example, the melting point may range from 80, 85, 90, 95, 100, 105, 110, 115, 120, 125, 130, 135, 140° C., about 100° C. to about 135° C.

For example, the polymer may include at least one of polyolefin-based materials, polyolefin-based derivatives, polyolefin-based wax, acryl-based compounds, or a combination thereof. The polyolefin-based material may be or include at least one of polyethylene, polypropylene, or a mixture thereof. For example, the polymer may be or include polyethylene-based wax.

According to one example embodiment, the core may have a diameter ranging from about 200 nm to about 800 nm, for example, 200, 250, 300, 350, 400, 450, 500, 550, 600, 650, 700, 750, 800 nm, 200 nm or more and less than 800 nm, or 300 nm or more and less than 800 nm. Within the above range, a core-shell particle having the above-described particle diameter D50 may be prepared.

According to one example embodiment, a melting point range of the shell is not limited as long as the shell has a melting point that is higher than the melting point of the organic component. For example, the shell, that is, the inorganic component of the shell, may have a melting point of about 1000° C. or higher, for example, 1000, 1100, 1200, 1300, 1400, 1500, 1600, 1700, 1800, 1900, 2000° C., ranging from about 1000° C. to about 2000° C. Within the above range, a shape of the core-shell particle can be readily maintained in the hot pressing process, and the core-shell particle may be readily destroyed in the event of a fire, making it easier to provide the shutdown function.

According to one example embodiment, the shell may include at least one of silica (e.g., SiO₂), alumina (Al₂O₃), Al(OH)₃, AlO(OH), TiO₂, BaTiO₂, ZnO₂, Mg(OH)₂, MgO, Ti(OH)₄, aluminum nitride (AlN), silicon carbide (SiC), boron nitride (BN), boehmite, or a combination thereof. For example, the shell may include one or more of silica, alumina, and boehmite, for example, silica.

According to one example embodiment, the core-shell particle may have a true spherical, deformed spherical, or amorphous shape.

According to one example embodiment, the first particle, that is, the core-shell particle, may be included in an amount ranging from about 60 wt % to about 99 wt % of the coating layer, for example, from 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 wt %, 60 wt % to 90 wt % or from 70 wt % to 90 wt %. Within the above range, it may be easier to provide a shutdown function and provide increased heat resistance by a second particle to be described below.

The core-shell particle may be prepared by conventional methods known to those skilled in the art. For example, the core-shell particle may be manufactured according to the examples below.

The filler may further include the second particle that differs from the first particle. The second particle may be or include a core-shell particle or a non-core-shell particle.

According to one example embodiment, the second particle can increase the heat resistance of the coating layer and reduce a shrinkage rate of the separator, thereby increasing the lifetime of the battery.

According to one example embodiment, the first particle and the second particle in the coating layer may be included in a weight ratio of about 65:35 to about 95:5 with respect to a total of 100 parts by weight of the first particle and the second particle. For example, the weight ratio may be 65:35, 70:30, 75:25, 80:20, 85:15, 90:10, 95:5, 70:30 to 90:10. Within the above range, it may be easier to achieve heat resistance and shutdown effects and to secure the air permeability, coating density, and ionic conductivity of the separator.

According to one example embodiment, the second particle may have a smaller particle diameter D50 than the first particle. For example, the second particle may have a particle diameter D50 of about 700 nm or less, for example, 200, 250, 300, 350, 400, 450, 500, 550, 600, 650, 700 nm, ranging from 200 nm to 500 nm or from 200 nm to 300 nm. Within the above range, thin film coating is possible, making it easier to secure pores in the coating layer.

The second particle may be or include an inorganic particle, an organic particle, an organic-inorganic composite particle, or a combination thereof. The inorganic particle may be or include a ceramic material capable of increasing heat resistance. The inorganic particle may include, for example, at least one of a metal oxide, a metalloid oxide, a metal fluoride, a metal hydroxide, or a combination thereof. The inorganic particle may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic particle may include at least one of an acrylic compound, an imide compound, an amide compound, or a combination thereof, but is not limited thereto. The organic particle may have a core-shell structure, but is not limited thereto.

The second particle may be substantially spherical, substantially plate-shaped, substantially cubic, or amorphous.

For example, the second particle may be or include plate-shaped boehmite.

According to one example embodiment, the second particle may be included in an amount ranging from about 5 wt % to 40 wt % of the coating layer, for example, from 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 wt %, 5 wt % to 35 wt % or from 10 wt % to 30 wt %. Within the above range, it is possible to secure the pores of the coating layer and achieve the shutdown characteristics of the coating layer.

The filler should be included in an appropriate amount with respect to the binder. According to one example embodiment, the binder and the filler may be included in a weight ratio of about 1:10 to about 1:50, for example, 1:20 to 1:30. Within the above range, it may be easier to provide the shutdown function by adding the filler and to manufacture the coating layer.

The filler may be contained in an amount ranging from about 50 wt % to about 99 wt %, for example, from 70 wt % to 99 wt %, from 75 wt % to 99 wt %, from 80 wt % to 99 wt %, from 85 wt % to 99 wt %, from 90 wt % to 99 wt %, or from 95 wt % to 99 wt % of the total amount of the coating layer. When the filler is included within the above range, the separator may exhibit desired or improved heat resistance, durability, oxidation resistance, and stability.

The binder may be configured to form the coating layer. In addition, when the melting point of the binder is high, it is possible to increase the heat resistance of the coating layer.

According to one example embodiment, the binder may include one or more of a structural unit derived from (meth)acrylate or (meth)acrylic acid, a cyano group-containing structural unit, a sulfonate group-containing structural unit, a structural unit derived from (meth)acryl amide, and a structural unit derived from hydroxyalkyl (meth)acrylate.

In the structural unit derived from (meth)acrylate or (meth)acrylic acid, the (meth)acrylate may be or include at least one of a conjugate base of (meth)acrylic acid, a (meth)acrylic acid salt, or a derivative thereof. The structural unit derived from (meth)acrylate or (meth)acrylic acid may be represented, for example, by at least one of Chemical Formula 1, 2, 3 below, or a combination thereof:

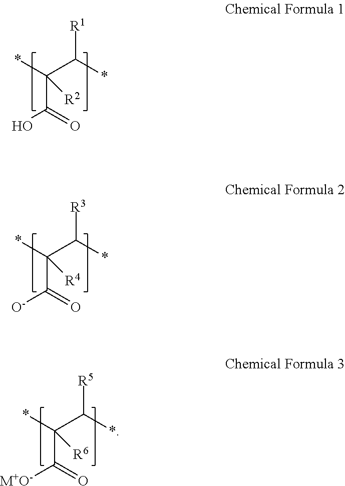

In Chemical Formulas 1 to 3,
R₁ to R₆ each independently is or includes hydrogen or a methyl group, and
in Chemical Formula 3,
M is or includes an alkali metal.

The alkali metal may be or include, for example, at least one of lithium, sodium, potassium, rubidium, or cesium.

The structural unit derived from (meth)acrylate or (meth)acrylic acid may be included in the (meth)acryl-based binder in an amount ranging from about 0 mol % to about 70 mol %, for example, from 0 mol % to 60 mol %, from 0 mol % to 50 mol %, from 5 mol % to 70 mol %, from 10 mol % to 70 mol %, from 10 mol % to 60 mol %, from 10 mol % to 50 mol %, from 20 mol % to 60 mol %, or from 30 mol % to 60 mol %. When the structural unit derived from (meth)acrylate or (meth)acrylic acid is included in the above range, a separator containing the (meth)acryl-based binder can exhibit desired or improved bonding strength, heat resistance, air permeability, and oxidation resistance.

The cyano group-containing structural unit may be, for example, represented by Chemical Formula 4 below:

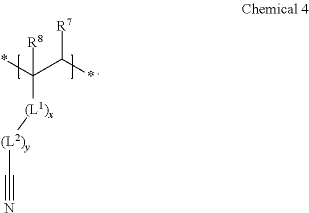

In Chemical Formula 4,
R⁷ and R⁸ each independently is or includes hydrogen or a C1 to C3 alkyl group,
L¹ is or includes-C(═O)—, —C(═O)O—, —OC(═O)—, —O—, or —C(═O) NH—,
x is an integer ranging from 0 to 2,
L² is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer ranging from 0 to 2.

The cyano group-containing structural unit may be or include, for example, at least one of a structural unit derived from (meth)acrylonitrile, an alkene nitrile, cyanoalkyl (meth)acrylate, or 2-(vinyloxy)alkanenitrile. Herein, the alkene may be or include at least one of a C1 to C20 alkene, a C1 to C10 alkene, or a C1 to C6 alkene, the alkyl may be or include at least one of a C1 to C20 alkyl, a C1 to C10 alkyl, or a C1 to C6 alkyl, and the alkane may be or include at least one of a C1 to C20 alkane, a C1 to C10 alkane, or a C1 to C6 alkane.

The alkene nitrile may be or include, for example, at least one of allyl cyanide, 4-pentenenitrile, 3-pentenenitrile, 2-pentenenitrile, 5-hexenenitrile, etc. The cyanoalkyl (meth)acrylate may be or include, for example, at least one of cyanomethyl (meth)acrylate, cyanoethyl (meth)acrylate, cyanopropyl (meth)acrylate, cyanooctyl (meth)acrylate, etc. The 2-(vinyloxy)alkanenitrile may be or include, for example, at least one of 2-(vinyloxy) ethanenitrile, 2-(vinyloxy) propanenitrile, etc.

The cyano group-containing structural unit may be included in the (meth)acryl-based binder in an amount ranging from about 0 mol % to about 85 mol %, for example, from 30 mol % to 85 mol %, from 40 mol % to 85 mol %, from 30 mol % to 70 mol %, from 30 mol % to 60 mol %, or from 35 mol % to 55 mol %. When the cyano group-containing structural unit is included within the above range, the (meth)acryl-based binder and the separator including the same can achieve a desired or improved oxidation resistance and exhibit a desired or improved bonding strength, heat resistance, and air permeability.

The sulfonate group-containing structural unit may be or include at least one of a structural unit containing a conjugate base of sulfonic acid, a sulfonate salt, sulfonic acid, or a derivative thereof. For example, the sulfonate group-containing structural unit may be represented by at least one of Chemical Formula 5, 6, 7 below, or a combination thereof.

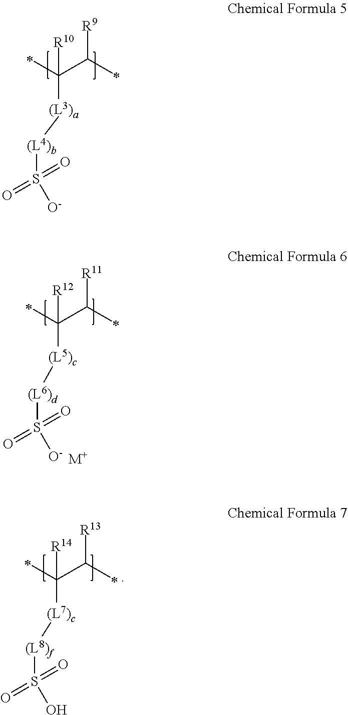

In Chemical Formulas 5 to 7,
R⁹ to R¹⁴ each independently is or includes hydrogen or a C1 to C3 alkyl group,
L³, L⁵, and L⁷ each independently is or includes —C(═O)—, —C(═O)O—, —OC(═O)—, —O—, or —C(═O) NH—,
L⁴, L⁶, and L⁸ each independently is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, d, e, and f are each independently an integer ranging from 0 to 2, and
in Chemical Formula 6,
M′ is or includes an alkali metal.

For example, in Chemical Formulas 5 to 7,
L³, L⁵, and L⁷ each independently is or includes —C(═O) NH—,
L⁴, L⁶, and L⁸ each independently is or includes a C1 to C10 alkylene group, and
a, b, c, d, e, and f may each be an integer equal to 1.

The sulfonate group-containing structural unit may include only one, or two or more, of the structural unit represented by Chemical Formula 5, the structural unit represented by Chemical Formula 6, and the structural unit represented by Chemical Formula 7. As an example, the sulfonate group-containing structural unit may include the structural unit represented by Chemical Formula 6, and as another example, the sulfonate group-containing structural unit may include the structural unit represented by Chemical Formula 6 and the structural unit represented by Chemical Formula 7.

The sulfonate group-containing structural unit may be or include, for example, at least one of a structural unit derived from vinyl sulfonic acid, allyl sulfonic acid, styrene sulfonic acid, anethole sulfonic acid, (meth)acrylamidoalkane sulfonic acid, sulfoalkyl (meth)acrylate, or salts thereof.

Here, the alkane may be or include at least one of a C1 to C20 alkane, a C1 to C10 alkane, or a C1 to C6 alkane, and the alkyl may be or include at least one of a C1 to C20 alkyl, a C1 to C10 alkyl, or a C1 to C6 alkyl. The salt may be composed of the above-described sulfonic acid and an appropriate ion. The ion may be or include, for example, an alkali metal ion, and in this case, the salt may be an alkali metal salt of sulfonic acid.

The (meth)acrylamidoalkane sulfonic acid may be or include, for example, 2-(meth)acrylamido-2-methylpropanesulfonic acid, and the sulfoalkyl (meth)acrylate may be or include, for example, at least one of 2-sulfoethyl (meth)acrylate, 3-sulfopropyl (meth)acrylate, and the like.

The cyano group-containing structural unit may be included in the (meth)acryl-based binder in an amount ranging from about 0.1 mol % to 70 mol %, for example, from 0.1 mol % to 60 mol %, from 0.1 mol % to 20 mol %, from 0.1 mol % to 10 mol %, from 1 mol % to 20 mol %, from 1 mol % to 10 mol %, from 1 mol % to 70 mol %, or from 1 mol % to 60 mol %. Within the above range, the (meth)acryl-based binder and the separator including the same may readily exhibit desired or improved bonding strength, heat resistance, air permeability, and oxidation resistance.

The structural unit derived from (meth)acrylamide may be represented by Chemical Formula 8 below.

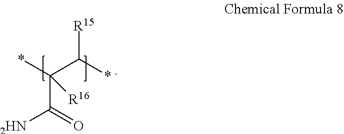

In Chemical Formula 8,
R¹⁵ and R¹⁶ each independently is or includes hydrogen or a methyl group.

The structural unit derived from the (meth)acrylamide may be included in the (meth)acryl-based binder in an amount ranging from about 0 mol % to about 95 mol %, for example, from 10 mol % to 95 mol %, from 10 mol % to 90 mol %, from 10 mol % to 95 mol %, from 20 mol % to 90 mol %, from 20 mol % to 95 mol %, from 30 mol % to 90 mol %, from 30 mol % to 95 mol %, from 40 mol % to 95 mol % or from 40 mol % to 90 mol %. The (meth)acryl-based binder and the separator including the same can achieve desired or improved oxidation resistance and exhibit desired or improved bonding strength, heat resistance, and air permeability.

The structural unit derived from hydroxyalkyl (meth)acrylate may be represented by Chemical Formula 9 below:

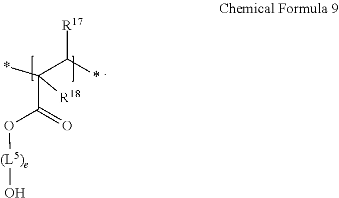

In Chemical Formula 9,
R¹⁷ and R¹⁸ are or include hydrogen or a C1 to C5 alkyl group,
L⁵ is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
e is an integer ranging from 0 to 2.

R¹⁷ and R¹⁸ may each independently be or include hydrogen or a methyl group, L⁵ may be or include a methylene group or an ethylene group, and e may be equal to 1.

The structural unit derived from hydroxyalkyl (meth)acrylate may be contained in the (meth)acryl-based binder in an amount ranging from about 0 mol % to about 20 mol %, for example, from 5 mol % to 15 mol %. The (meth)acryl-based binder and the separator including the same can achieve a desired or improved oxidation resistance and exhibit a desired or improved bonding strength, heat resistance, and air permeability.

According to one example embodiment, the binder includes a (meth)acryl-based binder containing a sulfonate group-containing structural unit. The (meth)acryl-based binder including a sulfonate group-containing structural unit can contribute to increasing heat resistance when included in the coating layer together with the filler.

According to one example embodiment, the binder includes a (meth)acryl-based binder containing a structural unit derived from (meth)acrylamide. The (meth)acryl-based binder containing a structural unit derived from (meth)acrylamide can contribute to increasing heat resistance when included in the coating layer together with the filler.

According to one example embodiment, the (meth)acryl-based binder may include at least one of a sulfonate group-containing structural unit, a structural unit derived from (meth)acrylate or (meth)acrylic acid, and a cyano group-containing structural unit.

According to one example embodiment, the (meth)acryl-based binder may include at least one of a sulfonate group-containing structural unit, a structural unit derived from (meth)acrylate or (meth)acrylic acid, and a structural unit derived from (meth)acrylamide.

According to one example embodiment, the (meth)acryl-based binder may include at least one of a sulfonate group-containing structural unit, a structural unit derived from (meth)acrylate or (meth)acrylic acid, and a structural unit derived from hydroxyalkyl (meth)acrylate.

The (meth)acryl-based binder may include an alkali metal. The alkali metal may be present in the form of a cation and for example, may be or include at least one of lithium, sodium, potassium, rubidium, or cesium. For example, the alkali metal may be combined with the (meth)acryl-based binder, and may be present in the form of a salt. The alkali metal may assist in the synthesis of the (meth)acryl-based binder in an aqueous solvent, increase the bonding strength of the coating layer, and increase the heat resistance, air permeability, oxidation resistance, etc. of the separator.

The alkali metal may be included in an amount ranging from about 1 wt % to about 40 wt % of the alkali metal and the (meth)acryl-based binder, for example, from 1 wt % to 30 wt %, from 1 wt % to 20 wt %, or from 10 wt % to 20 wt %. For example, the (meth)acryl-based binder and the alkali metal may be included in a weight ratio in a range of about 99:1 to about 60:40, a weight ratio of 99:1 to 70:30, for example, a weight ratio of 99:1 to 80:20, for example, a weight ratio of 90:10 to 80:20.

The alkali metal may be included in an amount ranging from about 0.1 mol % to about 1.0 mol % with respect to the total content of the alkali metal and the (meth)acryl-based binder. When the alkali metal is included within the above range, the coating layer can have a desired or improved bonding strength, and a separator including the same can exhibit a desired or improved heat resistance, air permeability, and oxidation resistance.

The (meth)acryl-based binder may be in various forms, such as an alternating polymer in which the units are alternately distributed, a random polymer in which the units are randomly distributed, or a graft polymer in which some structural units are grafted.

A weight average molecular weight (Mw) of the (meth)acryl-based binder may range from about 200,000 g/mol to about 700,000 g/mol, for example, 200,000 g/mol to 600,000 g/mol, or for example, 300,000 g/mol to 600,000 g/mol. When the weight average molecular weight of the (meth)acryl-based binder satisfies the above range, the (meth)acryl-based binder and the separator including the same can exhibit a desired or improved bonding strength, heat resistance, air permeability, and oxidation resistance. The weight average molecular weight may be or include a polystyrene-converted average molecular weight measured using gel permeation chromatography.

A glass transition temperature of the (meth)acryl-based binder may range from about 200° C. to about 280° C., for example, from 210° C. to 270° C., or for example, from 210° C. to 260° C. When the glass transition temperature of the (meth)acryl-based binder satisfies the above range, the (meth)acryl-based binder and the separator including the same can exhibit desired or improved bonding strength, heat resistance, air permeability, and oxidation resistance. The glass transition temperature may be a value measured by differential scanning calorimetry.

The (meth)acryl-based binder may be prepared by a solution polymerization method.

According to one example embodiment, the (meth)acryl-based binder may be contained in the coating layer of the separator in the form of a film.

The coating layer may have a thickness ranging from about 0.01 μm to about 20 μm, and within the above range, have a thickness ranging from 0.5 μm to 10 μm, from 0.7 μm to 5 μm, or from 0.7 μm to 3 μm.

A ratio of the thickness of the coating layer to the thickness of the porous substrate may range from about 0.05 to about 0.5, for example, from 0.05 to 0.4, from 0.05 to 0.3, or from 0.1 to 0.2. Within the above range, the separator can exhibit desired or improved air permeability, heat resistance, bonding strength, and the like. Here, “thickness of the coating layer” is a thickness of one coating layer when the coating layer is formed on only one surface of the porous substrate, and is a thickness of two coating layers when the coating layer is formed on both surfaces of the porous substrate.

### Porous Substrate

The porous substrate may be or include a substrate having multiple pores and commonly found in electrochemical devices. The porous substrate may be or include a polymer membrane formed of or including any one polymer such as or including at least one of a polyolefin such as polyethylene or polypropylene, polyester such as polyethylene terephthalate or polybutylene terephthalate, polyacetal, polyamide, polyimide, polycarbonate, polyether ether ketone, polyaryl ether ketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or a copolymer or mixture of two or more types thereof.

The porous substrate may be or include, for example, at least one of a polyolefin-based substrate containing a polyolefin, and the polyolefin-based substrate may have an desired or improved shutdown function, thereby contributing to increasing the safety of the battery. The polyolefin-based substrate may be or include at least one of, for example, a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin, or include a copolymer of olefin and non-olefin monomers.

The porous substrate may have a thickness ranging from about 1 μm to about 40 μm, for example, from 1 μm to 30 μm, from 1 μm to 20 μm, or from 5 μm to 15 μm.

The separator may further include an adhesive binder.

### Adhesive Binder

The adhesive binder can increase the bonding strength between an electrode such as a positive electrode or a negative electrode and the separator, thereby increasing the degree of bonding between the separator and the electrode.

The adhesive binder is a particle-type adhesive binder and may include, for example, one or more of a crosslinked or non-crosslinked (meth)acryl-based adhesive binder, and a crosslinked or non-crosslinked fluorine-based adhesive binder. As each of the (meth)acryl-based adhesive binder and the fluorine-based binder, common types known to those skilled in the art may be included.

According to one example embodiment, the adhesive binder may have a glass transition temperature of about 50° C. or higher, for example, in the range of 50° C. to 100° C. Within the above range, it is possible to improve cell performance by exhibiting adhesion to the electrode plate after a cell process.

According to one example embodiment, the adhesive binder may be included in the coating layer. For example, since the coating layer may be formed of or include a composition including the (meth)acryl-based binder, the filler, and the adhesive binder, the coating layer may include the (meth)acryl-based binder, the filler, and the adhesive binder.

According to another example embodiment, the adhesive binder forms an adhesive layer, and the adhesive layer may be located on the coating layer.

The separator for a rechargeable lithium battery according to one example embodiment may have desired or improved bonding strength. For example, the separator for a rechargeable lithium battery may have a bonding strength of about 0.05 gf/mm or more, for example, in the range of 0.05 gf/mm to 0.5 gf/mm, for example, 0.05 gf/mm to 0.7 gf/mm. The bonding strength may be measured by the following method.

A separator for a rechargeable lithium battery is located between a positive electrode and a negative electrode, and the separator is bonded to the positive electrode and the negative electrode by passing between rolls with a pressure of 250 kgf at a speed of 150 mm/sec in an 80° C. chamber. Samples are manufactured by cutting the separator bonded to the positive electrode and the negative electrode to a width of 25 mm and a length of 50 mm. As a bonding strength measurement device, HT400 from Tinius Olsen is used. In the above sample, the separator is separated from a negative electrode plate by about 10 to 20 mm, then the separator is fixed to an upper grip and the negative electrode plate is fixed to a lower grip so that a gap between the grips is 20 mm, and then peeled by being pulled in a 180° direction. After the peeling is started at a peeling speed of 20 mm/min, an average value was obtained by measuring a force required to peel 40 mm three times. The average value is calculated as the average value of the measured values.

The separator for a rechargeable lithium battery according to one example embodiment can exhibit desired or improved air permeability, and have an air permeability value of, for example, less than about 200 sec/100 cc, for example, 190 sec/100 cc or less or 180 sec/100 cc or less. Herein, the air permeability refers to the time (seconds) it takes for 100 cc of air to pass through the unit thickness of the separator at a constant pressure. The air permeability per unit thickness may be obtained by measuring the air permeability for the total thickness of the separator and dividing the air permeability by the thickness. The air permeability may be obtained by measuring the time it takes for 100 cc of air to pass through the separator using an air permeability measurement device (EG01-55-1MR, Asahi Seiko Co., Ltd.).

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material.

For example, the positive electrode may further include an additive that can be configured as a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be included.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be included. LiₐA_{1-b}X_{b}O_{2-c}D_{c} (0.90≤a≤1.8, 0≤b≤0.5, and 0≤c≤0.05); LiₐMn_{2-b} X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal, excluding lithium in the lithium transition metal composite oxide. The high-nickel-based positive electrode active material may be capable of realizing high capacity and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder is configured to attach the positive electrode active material particles to each other and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be included to impart conductivity (e.g., electrical conductivity) to the electrode. Any material that does not cause chemical change (e.g., that does not cause an undesirable chemical change in the rechargeable lithium battery), and that conducts electrons, can be included in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, etc., in a form of a metal powder or a metal fiber; a conductive polymer such as a polyphenylene derivative; or a mixture thereof.

Al may be included as the current collector, but is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon, and silicon particles and an amorphous carbon coating layer on a surface of the core.

The Si-based negative electrode active material or the Sn-based negative electrode active material may be combined with a carbon-based negative electrode active material.

The binder may be configured to attach the negative electrode active material particles to each other, and to attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be included to impart conductivity (e.g., electrical conductivity) to the electrode. Any material that does not cause chemical change (e.g., that does not cause an undesirable chemical change in the rechargeable lithium battery), and that conducts electrons, can be included in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, etc. in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may be configured as a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, a double bond, an aromatic ring, or an ether bond, and the like; amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed, and the cyclic carbonate and the chain carbonate may be mixed in a volume ratio of about 1:1 to about 1:9.

The lithium salt dissolved in the organic solvent is configured to supply lithium ions in a battery, enable a basic operation of a rechargeable lithium battery, and improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

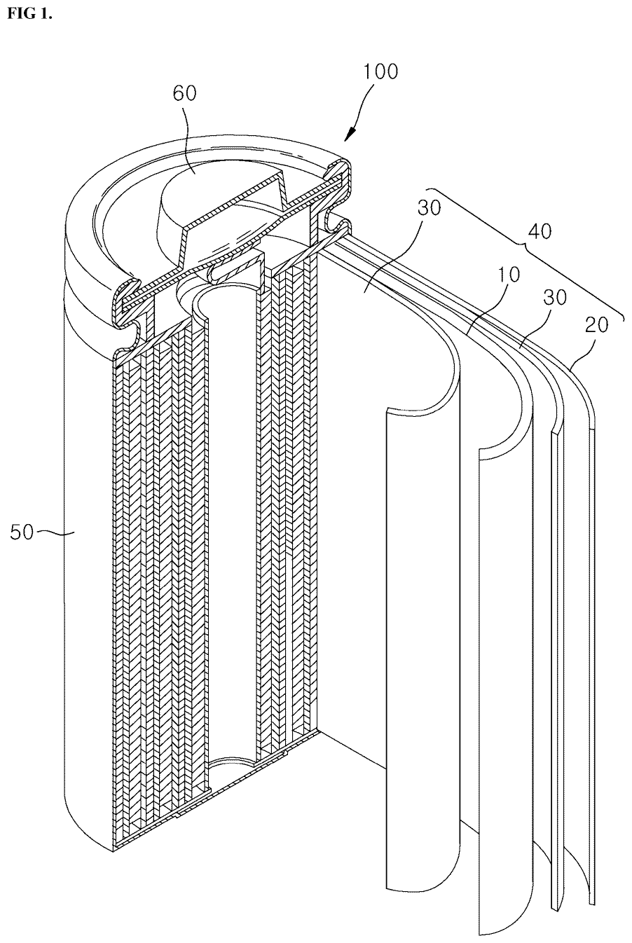

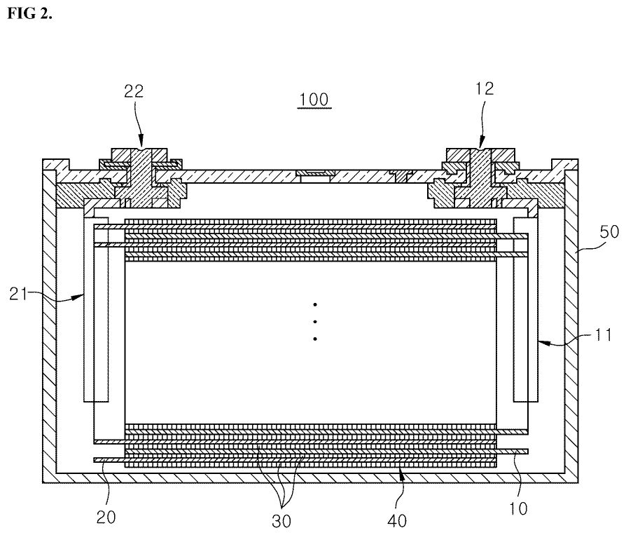

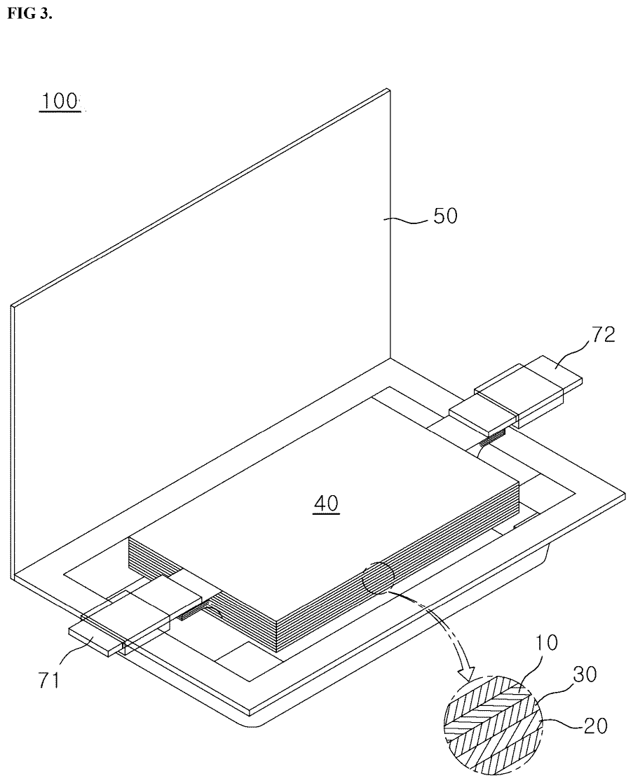

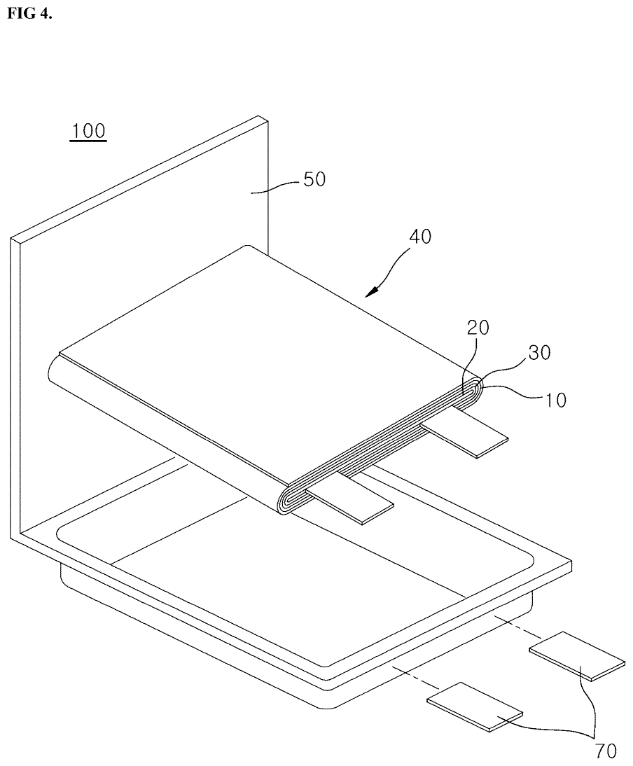

FIGS. 1 to 4 are schematic views illustrating a rechargeable lithium battery according to an example embodiment. FIG. 1 illustrates a cylindrical battery, FIG. 2 illustrates a prismatic battery, and FIGS. 3 and 4 illustrate pouch-type batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 1. In FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 may include an electrode tab 70 illustrated in FIG. 4, or, for example, a positive electrode tab 71 and a negative electrode tab 72 illustrated in FIG. 3, the electrode tabs 70/71/72 forming an electrical path for inducing the current formed in the electrode assembly 40 to the outside of the battery 100.

The rechargeable lithium battery according to an example embodiment may be applied to, e.g., automobiles, mobile phones, and/or various types of electric devices, as non-limiting examples.

Hereinafter, examples and comparative examples of the present disclosure are described. However, the following examples are merely example embodiments of the present disclosure, and the present disclosure is not limited to the following examples.

### Preparation Example 1

In a 10 L four-necked flask provided with a stirrer, a thermometer, and a cooling tube, a process of adding distilled water (6361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and a 5N aqueous lithium hydroxide solution (1.05 equivalents with respect to a total amount of 2-acrylamido-2-methylpropanesulfonic acid), then reducing an internal pressure to 10 mmHg using a diaphragm pump, and returning the internal pressure to a normal pressure using nitrogen was repeated three times.

The reaction was carried out for 12 hours while controlling the temperature of the reaction solution to be stable between 65° C. and 70° C. After cooling to room temperature, the pH of the reaction solution was adjusted to 7 to 8 using a 25% aqueous ammonia solution.

In this way, poly (acrylic acid-co-acrylamide-co-2-acrylamide-2-methylpropanesulfonic acid) lithium salt (melting point: 170° C.) was prepared. A molar ratio of acrylic acid, acrylamide, 2-acrylamido-2-methylpropane sulfonic acid was 10:85:5. A non-volatile component in about 10 mL of the reaction solution (reaction product) was measured and the measurement result was 9.5 wt % (theoretical value: 10%).

### Preparation Example 2

An acryl-based binder was prepared in the same manner as Preparation Example 1, with a difference that acrylic acid and acrylamide were used and 2-acrylamido-2-methylpropane sulfonic acid was not used. A molar ratio of acrylic+acrylic acid lithium salt and acrylamide was 42:58. The non-volatile component of the reaction solution was 9.0 wt % (theoretical value: 10%).

### Example 1

### (1) Preparation of Core-Shell Particle

A melt was prepared by mixing 0.2 g of polyethylene-based wax powder (melting point 110° C.) with 0.051 g of polyethylene-b-polyethylene glycol as a surfactant, and melting the same by heating at 145° C. until completely transparent. Xylene was heated to 140° C. and then added to the melt. Then, in a state of maintaining 140° C., 2 ml of tetraethoxysilane (silica precursor) was added and stirred at 140° C. Then, 50 ml of boiling ethanol and 30 ml of ammonium hydroxide (NH₃—H₂O) were added. The obtained reaction solution was slowly cooled and stirred at room temperature for 12 hours. A powder was prepared by filtering, purifying, and drying the obtained product solution at 80° C. for 5 hours.

The obtained powder had a particle diameter D50 of 700 nm and was spherical. By measuring the light transmittance (units: %) according to the wave number (units: cm⁻¹) for each of the polyethylene-based wax, silica (SiO₂), and powder obtained above, the silica shell was formed on the polyethylene-based wax core and a core-shell particle having an interpenetrating polymer-inorganic network structure between the core and the shell was prepared.

### (2) Manufacture of Separator

Boehmite (particle diameter D50: 300 nm, plate-shaped, 200SM, Nabaltec) was used as the second particle. A filler was prepared by mixing 80 parts by weight core-shell particles and 20 parts by weight boehmite based on a total of 100 parts by weight of the prepared core-shell particle and boehmite.

A slurry for forming a coating layer having 20 wt % solid content was prepared by mixing the (meth)acryl-based binder prepared in Preparation Example 1 with the filler in a weight ratio of 1:30 and mixing deionized water as a solvent.

A separator for a rechargeable lithium battery was manufactured by coating one surface of a polyethylene film (thickness: 5.5 μm, CZMZ Company, air permeability: 120 sec/100 cc, and puncture strength: 350 kgf) as a porous substrate with the slurry for forming a coating layer using a die coating method and then drying and aging the same in an oven at 80° C. for 16 hours.

A melting point of the porous substrate of the separator was 140° C., a melting point of the organic component of the core-shell particle was 110° C., and a melting point of silica, the inorganic component of the shell, was 1000° C. or higher.

### Examples 2 to 8

Separators for a rechargeable lithium battery were manufactured in the same manner as in Example 1, with a difference that in Example 1, the weight ratio of the core-shell particle and boehmite, coating thickness, and/or the type of (meth)acryl-based binder were changed as shown in Table 1 below.

### Comparative Example 1

A separator for a rechargeable lithium battery was manufactured in the same manner as in Example 1, with a difference that a polyethylene-based wax particle (particle diameter D50: 1.2 μm, spheric, PMD-01, Nanjing Tianshi New Material Technologies) was used instead of the core-shell particle.

### Comparative Examples 2 to 5

Separators for a rechargeable lithium battery were manufactured in the same manner as in Example 1, with a difference that in Comparative Example 1, the weight ratio of the core-shell particle and boehmite, coating thickness, and/or the type of (meth)acryl-based binder were changed as shown in Table 1 below.

Coating Density (Units: g/cm³)

A thickness (a) and a unit weight (b) of the porous substrate before coating the slurry for forming a coating layer were measured. After coating the slurry for forming a coating layer and drying and aging the same in an oven at 80° C. for 16 hours, a total thickness (c) and a unit weight (d) were measured, and a coating thickness (e) and a coating weight (f) were calculated. A coating density was calculated by dividing the coating weight by the coating thickness.
Coating thickness (e)=c−a
Coating weight (f)=d−b
Coating density=f/e
Air permeability (units: sec/100 cc)

For the separators manufactured in Examples and Comparative Examples, air permeability was measured by measuring the time (units: seconds) it took for 100 cc of air to pass through the separator using a measuring device (EG01-55-1MR, Asahi Seiko).

### Air Permeability Measurement Device Setting Conditions:

Measurement pressure: 0.5 kg/cm², cylinder pressure: 2.5 kg/cm², set time: 10 seconds

Change in Air Permeability Before and After Hot Pressing (Δ Air Permeability) (Units:sec/100 cc)

A slurry for a positive electrode was prepared by adding LiCoO₂, polyvinylidene fluoride, and carbon black to an N-methylpyrrolidone solvent in a weight ratio of 96:2:2. A positive electrode was manufactured by applying the slurry for a positive electrode on an aluminum thin film and drying and rolling the same.

Each of the separators manufactured in the Examples and the Comparative Examples was interposed between the manufactured positive electrodes, pressing (hot pressing) was performed at a pressure of 2.0 MPa for 1 hour in a 80° C. chamber, and the separator was separated from the electrode plate. The air permeability of the separator was measured in the same manner as above and a change in air permeability was calculated. An average value was obtained by measuring the change in air permeability three times.

Air Permeability after being Left at 130° C. For 1 Hour (Units: Sec/100 cc)

The separators manufactured in the Examples and the Comparative Examples were left for 1 hour in a 130° C. chamber, and air permeability was measured in the same manner as above.

TABLE 1

| | Example | | | | | | |
|---|---|---|---|---|---|---|---|
| | 1 | 2 | 3 | 4 | 5 | 6 | 7 |
| Binder | Preparation | Preparation | Preparation | Preparation | Preparation | Preparation | Preparation |
| | Example 1 | Example 1 | Example 1 | Example 1 | Example 1 | Example 1 | Example 1 |
| Weight ratio | 80:20 | 80:20 | 80:20 | 70:30 | 90:10 | 65:35 | 95:5 |
| Coating | 2.0 | 2.5 | 3.5 | 3.5 | 3.5 | 3.5 | 3.5 |
| thickness | | | | | | | |
| Coating | 2.42 | 3.05 | 4.2 | 4.8 | 4.12 | 2.42 | 2.42 |
| loading | | | | | | | |
| amount | | | | | | | |
| Coating | 1.21 | 1.22 | 1.2 | 1.37 | 1.18 | 1.41 | 1.1 |
| density | | | | | | | |
| Air | 123 | 125 | 128 | 130 | 139 | 128 | 138 |
| permeability | | | | | | | |
| Δ air | 1 | 3 | 1 | 2 | 2 | 1 | 5 |
| permeability | | | | | | | |
| Air | 28420 | 28750 | 29342 | 28932 | 29200 | 26921 | 30520 |
| permeability | | | | | | | |
| after being | | | | | | | |
| left for 1 | | | | | | | |
| hour at | | | | | | | |
| 130° C. | | | | | | | |
| | | Example | Comparative Example | | | | |
| | | 8 | 1 | 2 | 3 | 4 | 5 |
| | Binder | Preparation | Preparation | Preparation | Preparation | Preparation | Preparation |
| | | Example 2 | Example 1 | Example 1 | Example 1 | Example 1 | Example 1 |
| | Weight ratio | 80:20 | 80:20 | 80:20 | 80:20 | 70:30 | 90:10 |
| | Coating | 3.5 | 2 | 2.5 | 3.5 | 3.5 | 3.5 |
| | thickness | | | | | | |
| | Coating | 2.42 | 1.37 | 1.78 | 2.5 | 2.4 | 2.4 |
| | loading | | | | | | |
| | amount | | | | | | |
| | Coating | 1.22 | 0.69 | 0.71 | 0.71 | 0.69 | 0.69 |
| | density | | | | | | |
| | Air | 128 | 118 | 122 | 125 | 128 | 128 |
| | permeability | | | | | | |
| | Δ air | 1 | 20 | 25 | 38 | 30 | 70 |
| | permeability | | | | | | |
| | Air | 27854 | 1000 | 4800 | 28816 | 5500 | 28912 |
| | permeability | | | | | | |
| | after being | | | | | | |
| | left for 1 | | | | | | |
| | hour at | | | | | | |
| | 130° C. | | | | | | |

* Weight ratio in Table 1: weight ratio between core-shell particle and boehmite, or weight ratio between polyethylene-based wax particle and boehmite
* Δ air permeability in Table 1: Change in air permeability before and after hot pressing (sec/100 cc)

As shown in Table 1, the separators of the Examples have a lower A air permeability than the separators of the Comparative Examples, and have a higher air permeability than the separators of the Comparative Examples after being left for 1 hour at 130° C., and thus uniform cell characteristics and the shutdown function over the entire surface of the battery can be provided.

A separator for a rechargeable lithium battery according to one example embodiment can provide a high coating density in a small thickness, a uniform shutdown function over the entire surface of a battery, and a desired or improved battery manufacturing processability.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A separator for a rechargeable lithium battery, the separator comprising:
a porous substrate; and
a coating layer located on at least one surface of the porous substrate,
wherein the coating layer includes a binder and a filler,
the filler includes a core-shell particle as a first particle,
a core of the core-shell particle includes an organic component having a melting point that is lower than a melting point of the porous substrate, and
a shell of the core-shell particle includes an inorganic component having a melting point that is higher than the melting point of the organic component.

2. The separator of claim 1, wherein the core-shell particle has a particle diameter D50 of about 800 nm or less.

3. The separator of claim 1, wherein a thickness of the shell is about 10% or less of a diameter of the core.

4. The separator of claim 1, wherein the core comprises an interpenetrating polymer-inorganic network structure of the organic component and the inorganic component.

5. The separator of claim 1, wherein a melting point of the core ranges from about 80° C. to 140° C., and
a melting point of the shell is about 1000° C. or higher.

6. The separator of claim 1, wherein the organic component comprises at least one of a polyolefin-based material, a polyolefin-based derivative, a polyolefin-based wax, and an acryl-based compound.

7. The separator of claim 1, wherein the inorganic component comprises at least one of silica, alumina, Al(OH)₃, AlO(OH), TiO₂, BaTiO₂, ZnO₂, Mg(OH)₂, MgO, Ti(OH)₄, aluminum nitride (AlN), silicon carbide (SiC), and boron nitride (BN).

8. The separator of claim 1, wherein the core-shell particle is included in an amount in a range of about 60 wt % to about 99 wt % of the coating layer.

9. The separator of claim 1, wherein the filler further comprises a second particle that differs from the first particle.

10. The separator of claim 9, wherein the second particle comprises at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

11. The separator of claim 9, wherein the first particle and the second particle in the coating layer are included in a weight ratio in a range of about 65:35 to about 95:5 with respect to a total of 100 parts by weight of the first particle and the second particle.

12. The separator of claim 9, wherein the second particle has a smaller particle diameter D50 than the first particle.

13. The separator of claim 1, wherein the binder comprises one or more of a sulfonate group-containing structural unit, a structural unit derived from (meth)acrylate or (meth)acrylic acid, a cyano group-containing structural unit, a structural unit derived from (meth)acryl amide, and a structural unit derived from hydroxyalkyl (meth)acrylate.

14. The separator of claim 13, wherein the (meth)acryl-based binder comprises a sulfonate group-containing structural unit.

15. The separator of claim 13, wherein the sulfonate group-containing structural unit is represented by at least one of Chemical Formula 5, 6, and 7: 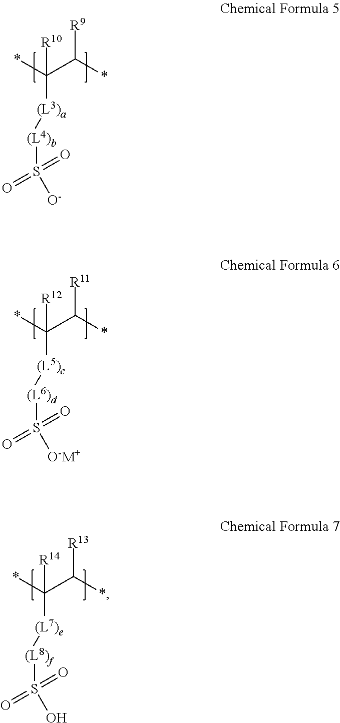
in Chemical Formulas 5 to 7,
R⁹ to R¹⁴ each independently comprises hydrogen or a C1 to C3 alkyl group,
L³, L⁵, and L⁷ each independently comprises —C(═O)—, —C(═O)O—, —OC(═O)—, —O—, or —C(═O) NH—,
L⁴, L⁶, and L⁸ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, d, e, and f are each independently an integer ranging from 0 to 2, and
in Chemical Formula 6,
M comprises an alkali metal.

16. The separator of claim 13, wherein the binder comprises a sulfonate group-containing structural unit, a structural unit derived from (meth)acrylate or (meth)acrylic acid, and a structural unit derived from (meth)acryl amide.

17. A rechargeable lithium battery comprising:
a positive electrode;
a negative electrode; and
the separator of claim 1 located between the positive electrode and the negative electrode.
